(19) United States
(12) Patent Application Publication
(10) Pub. No.: US 2025/0285034 A1
(43) Pub. Date: Sep. 11, 2025

(54) SYSTEMS AND METHODS FOR REDUCING HISTORICAL DATA-BASED BIAS IN MACHINE LEARNING MODELS

(71) Applicant: Verizon Patent and Licensing Inc., Basking Ridge, NJ (US)

(72) Inventor: Haripriya SRINIVASARAGHAVAN, Plano, TX (US)

(73) Assignee: Verizon Patent and Licensing Inc., Basking Ridge, NJ (US)

(21) Appl. No.: 18/598,143

(22) Filed: Mar. 7, 2024

(51) Int. Cl. G06N 20/20

(52) U.S. Cl. CPC G06N 20/20

(57) ABSTRACT

A device may remove protected dimensions from training data to generate modified training data, and may train a first model with the modified training data to generate a first trained model. The device may train a second model with the training data to generate a second trained model, and may utilize the first trained model to generate first predictions based on test data derived from the modified training data. The device may utilize the second trained model to generate second predictions based on the test data, and may determine whether correlations between the first predictions and the second predictions are less than a threshold. The device may selectively determine that the first trained model is bias-reduced based on the correlations being less than the threshold, or determine that the first trained model is biased based on the correlations not being less than the threshold.

### BACKGROUND

Model training is the process of providing a machine learning model with a significant amount of data so that the model can perform classification, identification, and prediction tasks. There are several types of training methods, including but not limited to supervised learning and unsupervised learning.

### BRIEF DESCRIPTION OF THE DRAWINGS

FIGS. 1A-1H are diagrams of an example associated with reducing bias in machine learning models.

FIG. 2 is a diagram of an example environment in which systems and/or methods described herein may be implemented.

FIG. 3 is a diagram of example components of one or more devices of FIG. 2.

FIG. 4 is a flowchart of an example process for reducing bias in machine learning models.

### DETAILED DESCRIPTION OF EXAMPLE EMBODIMENTS

The following detailed description of example implementations refers to the accompanying drawings. The same reference numbers in different drawings may identify the same or similar elements.

Statistical learning models, particularly within the domain of machine learning, are foundational for predicting future events based on historical data. However, the reliance on historical data can introduce significant biases into the learning process, perpetuating inequalities and resulting in unfair and/or undesirable outcomes and erroneous predictions. Biases in machine learning can arise from discriminatory practices, outdated models, or flawed data collection methods, leading to recommendations and decisions from machine learning models that reinforce disparities. This becomes more problematic when societal changes or legal reforms render past patterns obsolete, and when a distinction between correlation and causation in the historical data is blurred. Furthermore, machine learning models that have been trained with biased data may result in bias in detection, classification, and/or the like. Generative machine learning models may generate new data that is heavily oriented toward historical data upon which the new data is generated. Most probabilistic machine learning models (e.g., Bayesian models, probabilistic grammar-based models, and/or the like) can show bias, and detecting such bias in generative and probabilistic models is typically very difficult.

Thus, current techniques for training machine learning models consume computing resources (e.g., processing resources, memory resources, communication resources, and/or the like), networking resources, and/or other resources associated with generating biased machine learning models, generating biased predictions with the biased machine learning models, retraining the biased machine learning models, identifying and correcting bias in training data utilized to train the machine learning models, and/or the like.

Some implementations described herein provide an unbiasing system that reduces bias in machine learning models. For example, the unbiasing system may remove protected dimensions from training data to generated modified training data and may train a first model with the modified training data to create a bias-reduced model. The unbiasing system may train a second model with the original training data, and may compare predictions from both models to ensure reduced bias. The unbiasing system may also remove secondary dimensions highly correlated with the protected dimensions from the training data, and may add cross-augmented dimensions to the training data to replace the protected and correlated dimensions. The unbiasing system may remove trend-based information related to the protected dimensions to eliminate bias related to historical trends.

In this way, the unbiasing system reduces bias in machine learning models. For example, by removing data dimensions that are highly correlated with protected dimensions from the training data and reducing correlation of model predictions with protected dimensions, the unbiasing system may enhance the integrity and reliability of machine learning models. This may facilitate deployment of machine learning models in sensitive applications, and may conserve resources by reducing the need for subsequent bias correction measures and model retraining. Thus, the unbiasing system may conserve computing resources, networking resources, and/or other resources that would have otherwise been consumed by generating biased machine learning models, generating biased predictions with the biased machine learning models, retraining the biased machine learning models, identifying and correcting bias in training data utilized to train the machine learning models, and/or the like.

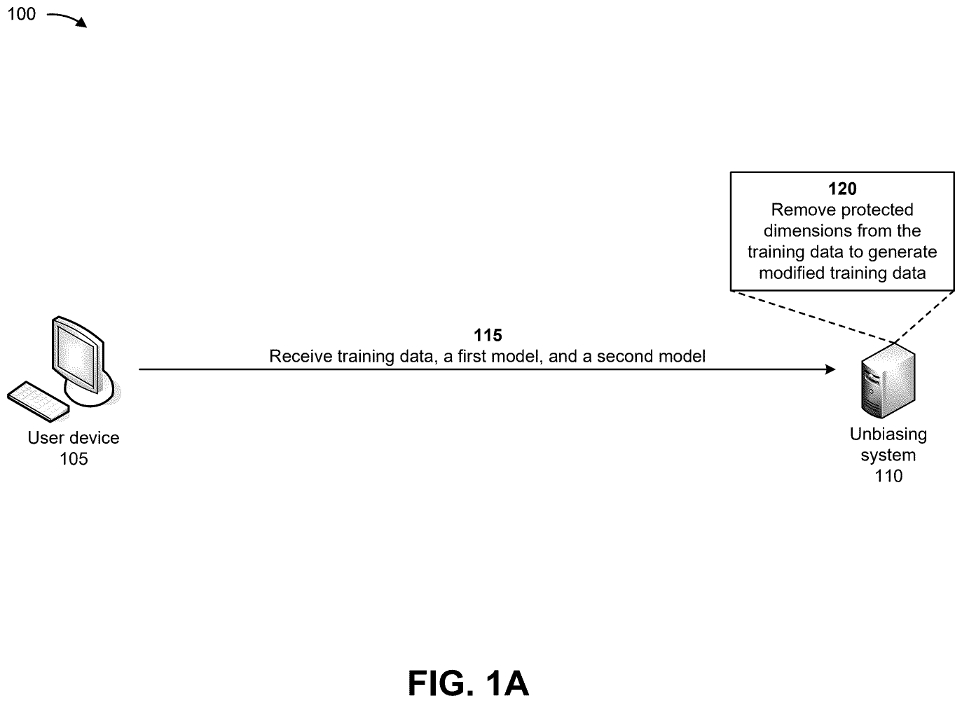

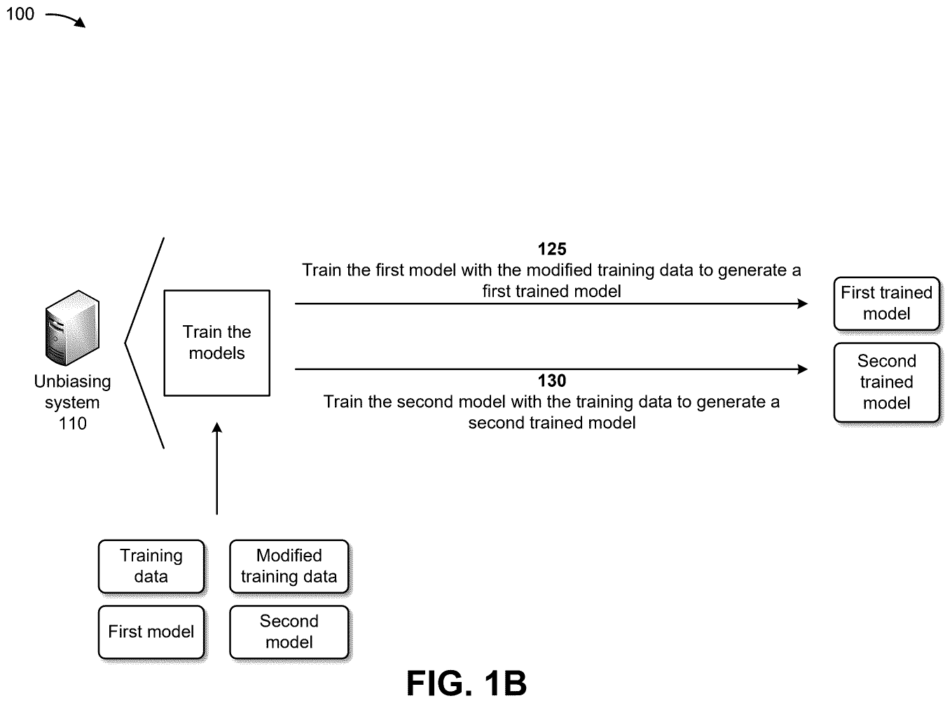

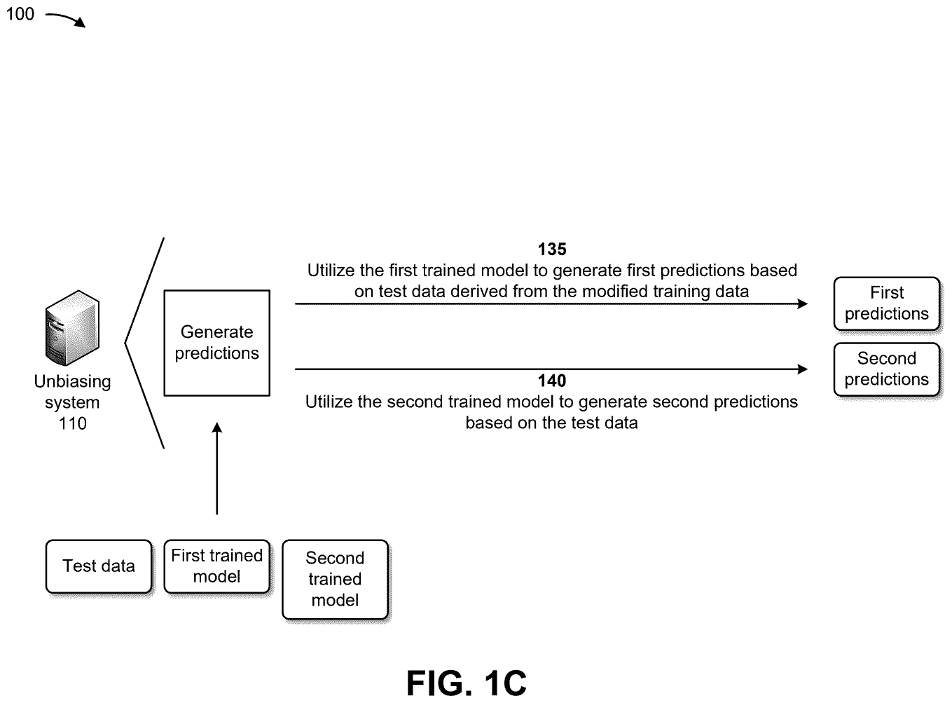

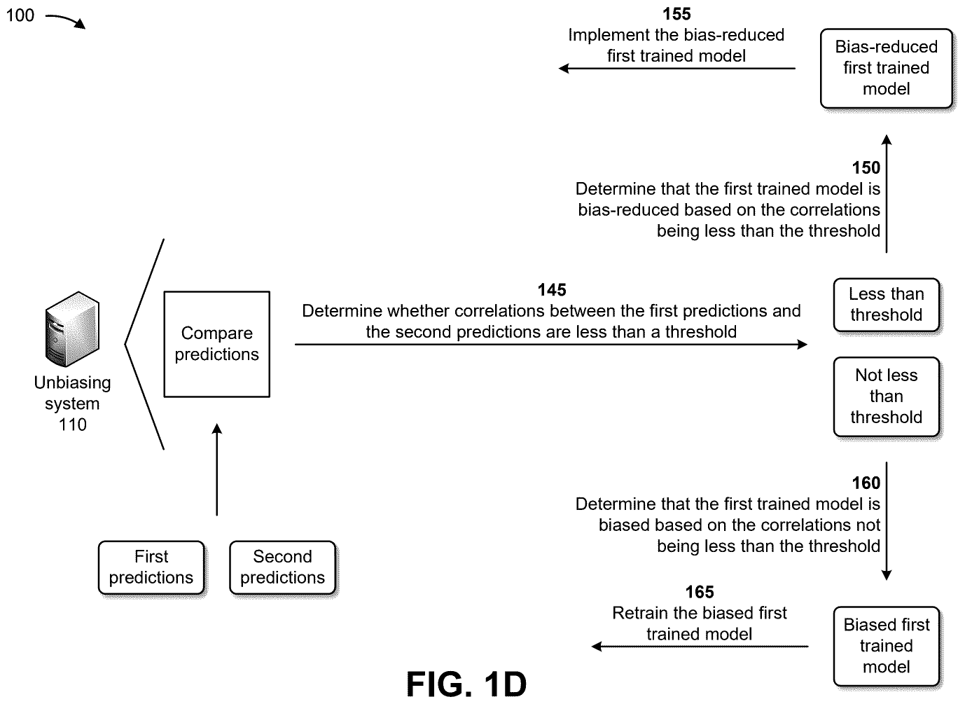

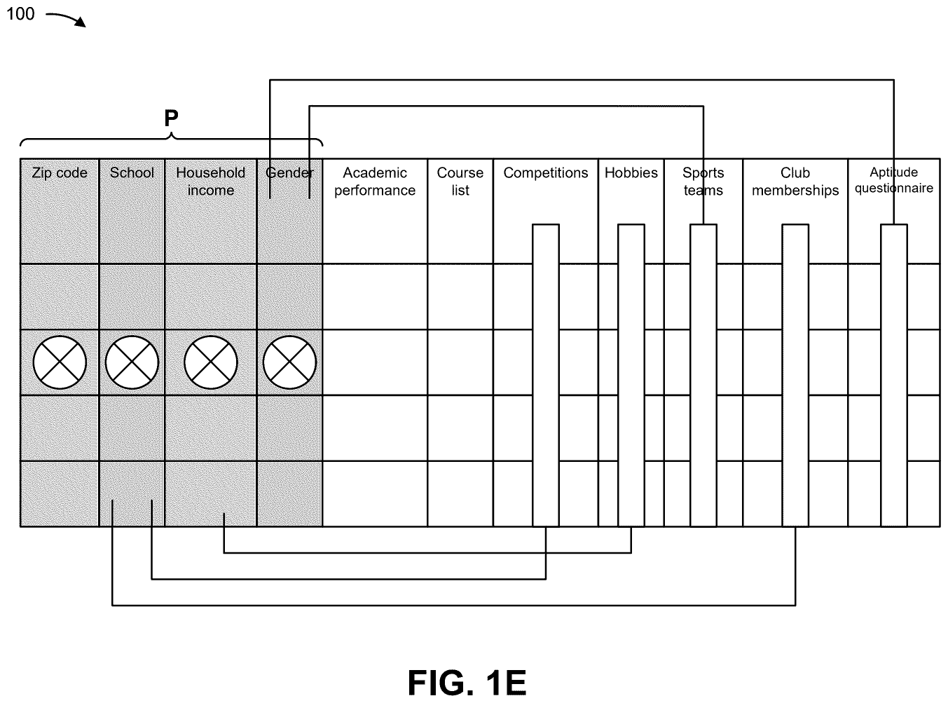

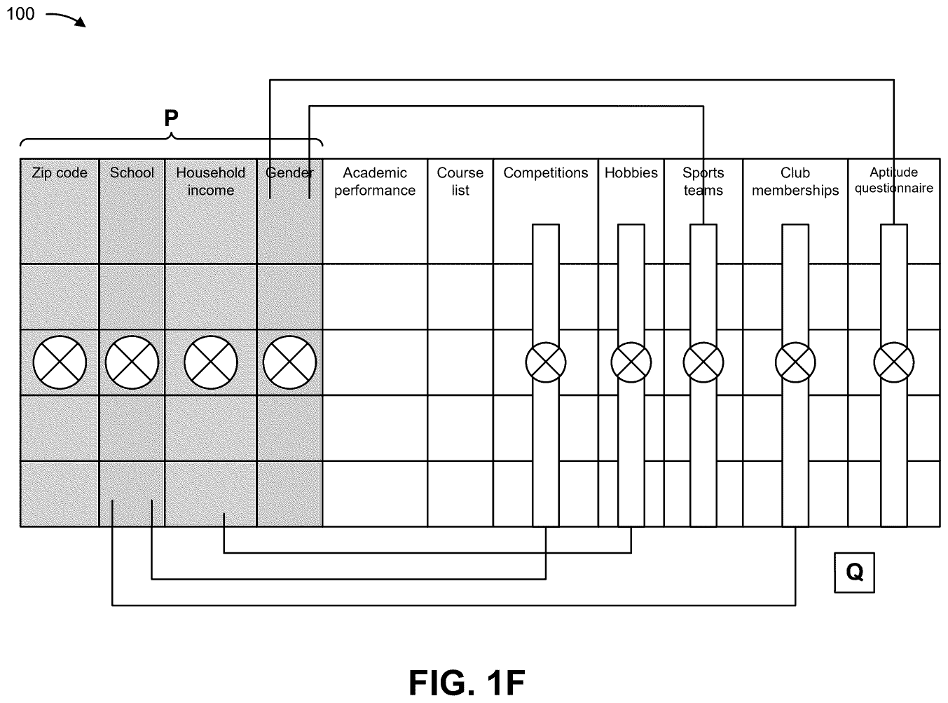

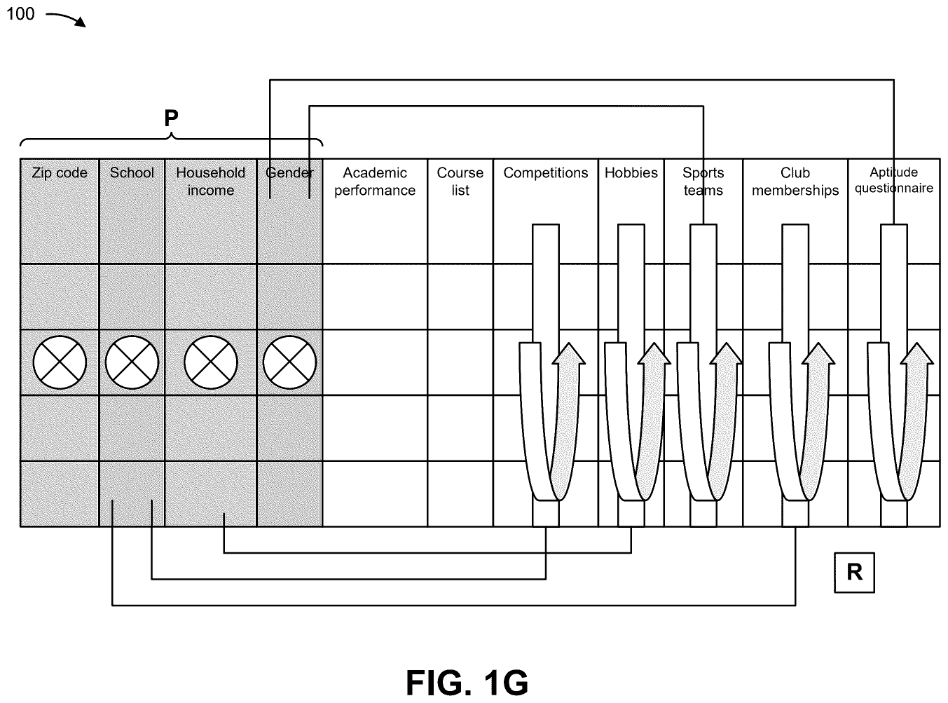

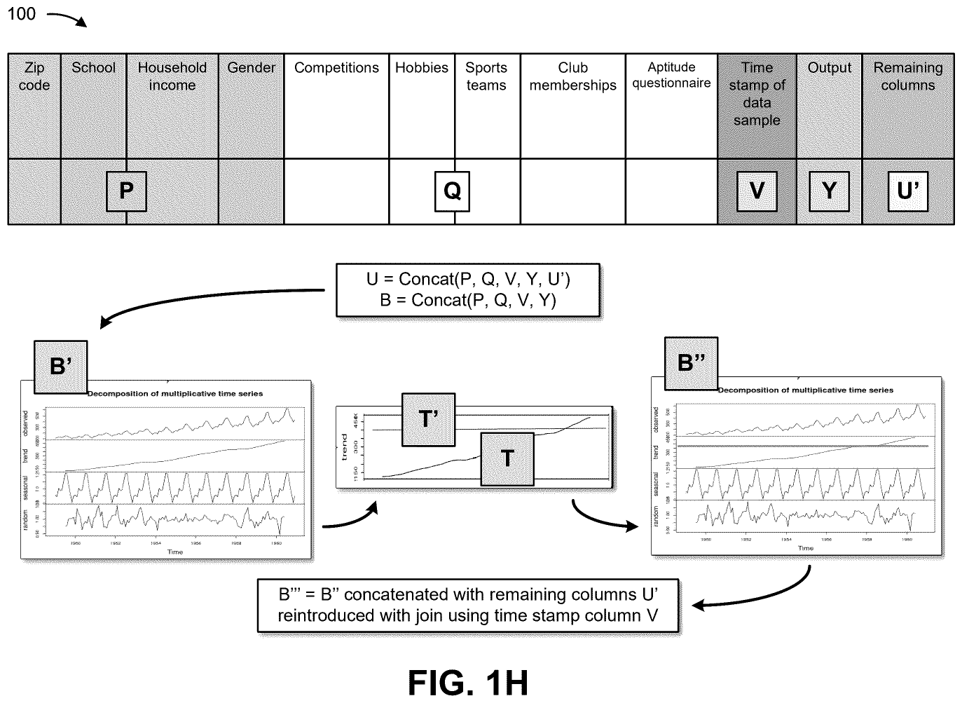

FIGS. 1A-1H are diagrams of an example 100 associated with reducing bias in machine learning models. As shown in FIGS. 1A-1H, example 100 includes a user device 105 associated with an unbiasing system 110. Further details of the user device 105 and the unbiasing system 110 are provided elsewhere herein.

As shown in FIG. 1A, and by reference number 115, the unbiasing system 110 may receive training data, a first model, and a second model. For example, the user device 105 may provide the training data, the first model, and the second model to the unbiasing system 110, and the unbiasing system 110 may receive the training data, the first model, and the second model from the user device 105. Alternatively, the unbiasing system 110 may receive the training data, the first model, and the second model from another source, such as a system that trains the first model and the second model with the training data and that utilizes the first model and the second model. In some implementations, the first model and the second model may be the same type of model. In some implementations, each of the first model and the second model may be a machine learning model (e.g., a model trained via supervised learning, such as a classification model, a linear regression model, a logistic regression model, and/or the like). The machine learning model may include a discriminatory model, a generative model, a probabilistic model (e.g., a Bayesian model, a probabilistic grammar-based model, etc.), and/or the like. The training data may be provided as a training data matrix that includes biased data (e.g., protected data or protected dimensions). A machine learning model that is trained with the biased training data may exhibit data bias. For example, a discriminatory model trained with the biased training data may generate bias in discrimination (e.g., detection, classification, and/or the like) based on the training data. A generative model may generate new data based on learning from the training data, which may result in new data that is heavily biased due to the biased training data (e.g., a generative model that writes a new job description based on biased job descriptions for a similar job may encode a pronoun of a candidate as “he/him” instead of “she/her” or “they/them”). A probabilistic model may also show bias when trained with the biased training data.

As further shown in FIG. 1A, and by reference number 120, the unbiasing system 110 may remove protected dimensions from the training data to generate modified training data. For example, the unbiasing system 110 may remove historically biased data from the training data to generate the modified training data. Data may be biased in a way that it includes certain data which corresponds to protected dimensions and/or categories, such as race, gender, etc. while these dimensions and/or categories may not be relevant to or properly represent the relationships between the control and predicted data. One such example is predicting SAT scores; while there likely is a relationship between GPA and SAT scores, such a relationship may not exist between gender and SAT scores, but the historical data may show a correlation and may cause the model to generate predictions that are influenced by this bias) For example, the training data may be represented as a training data matrix U, the protected dimensions or categories may be represented as P, and the training data may include a number (n) of samples. The training data matrix (U) may include a set of samples containing the number (n) of u-dimensional vectors (e.g., represented as an n×u matrix). The protected dimensions (P) may include a set of p protected dimensions (e.g., represented as an n×p matrix), and the modified training data (B) may include a matrix created by removing columns represented by the protected dimensions P from the training data matrix U (e.g., B is an n×(u−p) matrix).

As shown in FIG. 1B, and by reference number 125, the unbiasing system 110 may train the first model with the modified training data to generate a first trained model. For example, the first model may be trained using a set of observations. The set of observations may be obtained from the modified training data. The set of observations may include a feature set. The feature set may include a set of variables, and a variable may be referred to as a feature. A specific observation may include a set of variable values (or feature values) corresponding to the set of variables. In some implementations, the unbiasing system 110 may determine variables for a set of observations and/or variable values for a specific observation based on input received from the unbiasing system 110. For example, the unbiasing system 110 may identify a feature set (e.g., one or more features and/or feature values) by extracting the feature set from structured data, by performing natural language processing to extract the feature set from unstructured data, and/or by receiving input from an operator.

The set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, or labels), and/or may represent a variable having a Boolean value. A target variable may be associated with a target variable value, and a target variable value may be specific to an observation. The target variable may represent a value that the first model is being trained to predict, and the feature set may represent the variables that are input to the first trained model to predict a value for the target variable. The set of observations may include target variable values so that the first model can be trained to recognize patterns in the feature set that lead to a target variable value. A model that is trained to predict a target variable value may be referred to as a supervised learning model.

In some implementations, the first model may be trained on a set of observations that do not include a target variable. This may be referred to as an unsupervised learning method. In this case, the first model may learn patterns from data that is unlabeled (e.g., unsupervised), and may provide output that indicates such patterns, such as by using clustering and/or association to identify related groups of items within the set of observations.

The unbiasing system 110 may train the first model using the set of observations and using one or more machine learning algorithms, such as a regression algorithm, a decision tree algorithm, a neural network algorithm, a k-nearest neighbor algorithm, a support vector machine algorithm, or the like. After training, the unbiasing system 110 may store the first model as the trained first model to be used to create predictions for new observations.

As further shown in FIG. 1B, and by reference number 130, the unbiasing system 110 may train the second model with the training data to generate a second trained model. For example, the second model may be trained using a set of observations. The set of observations may be obtained from the training data. The set of observations may include a feature set. The feature set may include a set of variables, and a variable may be referred to as a feature. A specific observation may include a set of variable values (or feature values) corresponding to the set of variables. In some implementations, the unbiasing system 110 may determine variables for a set of observations and/or variable values for a specific observation based on input received from the unbiasing system 110. For example, the unbiasing system 110 may identify a feature set (e.g., one or more features and/or feature values) by extracting the feature set from structured data, by performing natural language processing to extract the feature set from unstructured data, and/or by receiving input from an operator.

The set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, or labels), and/or may represent a variable having a Boolean value. A target variable may be associated with a target variable value, and a target variable value may be specific to an observation. The target variable may represent a value that the second model is being trained to predict, and the feature set may represent the variables that are input to the second trained model to predict a value for the target variable. The set of observations may include target variable values so that the second model can be trained to recognize patterns in the feature set that lead to a target variable value. A model that is trained to predict a target variable value may be referred to as a supervised learning model.

In some implementations, the second model may be trained on a set of observations that do not include a target variable. This may be referred to as an unsupervised learning method. In this case, the second model may learn patterns from data that is unlabeled (e.g., unsupervised), and may provide output that indicates such patterns, such as by using clustering and/or association to identify related groups of items within the set of observations.

The unbiasing system 110 may train the second model using the set of observations and using one or more machine learning algorithms, such as a regression algorithm, a decision tree algorithm, a neural network algorithm, a k-nearest neighbor algorithm, a support vector machine algorithm, or the like. After training, the unbiasing system 110 may store the second model as the trained second model to be used to create predictions for new observations.

As shown in FIG. 1C, and by reference number 135, the unbiasing system 110 may utilize the first trained model to generate first predictions based on test data derived from the modified training data. For example, the unbiasing system 110 derives test data from the modified training data by excluding the protected dimensions (P) from the modified training data. The unbiasing system 110 may process the test data, with the first trained model, to generate the first predictions. The unbiasing system 110 may calculate first correlations between the first predictions and the biased protected dimensions.

As further shown in FIG. 1C, and by reference number 140, the unbiasing system 110 may utilize the second trained model to generate second predictions based on the test data. For example, the unbiasing system 110 may process the test data, with the second trained model, to generate the second predictions. The second predictions may include new observations without the protected dimensions. The unbiasing system 110 may calculate second correlations between the second predictions and the biased protected dimensions.

As shown in FIG. 1D, and by reference number 145, the unbiasing system 110 may determine whether the correlations respectively associated with the first predictions and the second predictions are less than a threshold. For example, the unbiasing system 110 may receive or determine a threshold (e.g., 2) associated with determining whether two sets of data (e.g., the predictions and the biased protected dimensions) are correlated. If correlations of the two sets of data are less than the threshold, the two sets of data may not be correlated. If correlations of the two sets of data are greater than or equal to the threshold, the two sets of data may be considered correlated for purposes of this disclosure. In some implementations, the unbiasing system 110 may utilize the second correlations between the second predictions and the biased protected dimensions to determine the threshold. In some implementations, the threshold may be pre-configured based on acceptable levels of correlations. For example, the threshold may be 0.7, 0.8, or 0.9 based on the levels of correlations that can be tolerated. The unbiasing system 110 may also generate models with different thresholds for correlation and may later determine which of these thresholds results in good predictions without exhibiting obvious correlations with protected dimensions. Alternatively, or additionally, the unbiasing system 110 may determine the threshold by identifying levels of correlations among different problem sets (e.g., GPA prediction, career path prediction, and/or the like) or by identifying data from different datasets or populations and determining an acceptable threshold based on the correlations that are obviously biased.

The unbiasing system 110 may determine whether the first correlations (e.g., [r]) between the first predictions and the biased protected dimensions are less than the threshold (e.g., |r|9 <λ). In some implementations, the unbiasing system 110 may determine that the first correlations between the first predictions and the biased protected dimensions are less than the threshold. Alternatively, the unbiasing system 110 may determine that the first correlations between the first predictions and the biased protected dimensions are not less than the threshold.

As further shown in FIG. 1D, and by reference number 150, the unbiasing system 110 may determine that the first trained model is bias-reduced based on the correlations being less than the threshold. For example, when the unbiasing system 110 determines that the first correlations between the first predictions and the biased protected dimensions are less than the threshold, the unbiasing system 110 may determine that the first trained model is bias-reduced (e.g., that the first trained model has been trained without considering the biased protected dimensions). In some implementations, the unbiasing system 110 may provide, for display, an indication that the first trained model is bias-reduced (e.g., to a user of the user device 105).

As further shown in FIG. 1D, and by reference number 155, the unbiasing system 110 may implement the first trained model based on determining that the first trained model is bias-reduced. For example, when the unbiasing system 110 determines that the first trained model is bias-reduced, the unbiasing system 110 may implement the first trained model in a system that utilizes the first model for predictions.

As further shown in FIG. 1D, and by reference number 160, the unbiasing system 110 may determine that the first trained model is biased based on the correlations not being less than the threshold. For example, when the unbiasing system 110 determines that the first correlations between the first predictions and the biased protected dimensions are not less than the threshold, the unbiasing system 110 may determine that the first trained model is biased (e.g., that the first trained model has been trained without considering the biased protected dimensions). In some implementations, the unbiasing system 110 may provide, for display, an indication that the first trained model is biased (e.g., to a user of the user device 105).

As further shown in FIG. 1D, and by reference number 165, the unbiasing system 110 may retrain the first trained model based on determining that the first trained model is biased. For example, when the unbiasing system 110 determines that the first trained model is biased, the unbiasing system 110 may retrain the first trained model with the modified training data. In some implementations, the unbiasing system 110 may further modify the modified training data prior to retraining the first trained model with the modified training data. The retraining loop utilizing the modified training data may be used to adjust the first trained model in an effort to reduce the first correlations to an acceptable level (e.g., below the threshold).

FIG. 1E depicts an example of eliminating bias from the training data and may be referred to as protected blind learning. For example, the training data may be represented as a training data matrix U, the protected dimensions or categories may be represented as P, and the training data may include a number (n) of samples. The training data matrix (U) may include a set of samples containing the number (n) of u-dimensional vectors (e.g., represented as an n×u matrix). The protected dimensions (P) may include a set of p protected dimensions (e.g., represented as an n×p matrix), and the modified training data (B) may include a matrix created by removing columns represented by the protected dimensions P from the training data matrix U (e.g., B is an n×(u−p) matrix).

The unbiasing system 110 may train the first model (M′) with the modified training data (B) and to generate the first trained model (M′). The unbiasing system 110 may train the second model (M) with the training data matrix (U) and to generate the second trained model (M). The unbiasing system 110 may process the test data, with the first trained model (M′), to generate the first predictions, and may process the test data, with the second trained model (M), to generate the second predictions. The unbiasing system 110 may calculate first correlations (r) between the first predictions and the biased protected dimensions (P), and may calculate second correlations between the second predictions and the biased protected dimensions (P). The unbiasing system 110 may determine whether the first correlations (e.g., |r|) between the first predictions and the biased protected dimensions are less than the threshold (e.g., |r|<λ). In some implementations, the unbiasing system 110 may determine that the first correlations between the first predictions and the biased protected dimensions are less than the threshold, which may indicate that the first model (M′) has been trained without considering the biased protected dimensions (P).

FIG. 1F depicts an example of eliminating bias from the training data and may be referred to as protected blind learning with correlations removed. For example, the training data may be represented as a training data matrix U, the protected dimensions or categories may be represented as P, and the training data may include a number (n) of samples. The training data matrix (U) may include a set of samples containing the number (n) of u-dimensional vectors (e.g., represented as an n×u matrix). The protected dimensions (P) may include a set of p protected dimensions (e.g., represented as an n×p matrix), and the modified training data (B) may include a matrix created by removing columns represented by the protected dimensions P from the training data matrix U (e.g., B is an n×(u−p) matrix). The unbiasing system 110 may also remove dimensions or a set of dimensions (e.g., represented by an n×q dimensional matrix Q) that are highly positively or negatively correlated higher than another threshold (ρ) (e.g., ρ=0.9 and r<−ρ or r>φ associated with the protected dimensions (P) from the training data (e.g., resulting in a set B′, where B′ is an n×(u−p−q) matrix).

The unbiasing system 110 may train the first model (M′) with the modified training data (B′) and to generate the first trained model (M′). The unbiasing system 110 may train the second model (M) with the training data matrix (U) and to generate the second trained model (M). The unbiasing system 110 may process the test data (e.g., derived from the set B′ rather than B), with the first trained model (M′), to generate the first predictions, and may process the test data, with the second trained model (M), to generate the second predictions. The unbiasing system 110 may calculate first correlations (r) between the first predictions and the biased protected dimensions (P), and may calculate second correlations between the second predictions and the biased protected dimensions (P). The unbiasing system 110 may determine whether the first correlations (e.g., |r|) between the first predictions and the biased protected dimensions are less than the threshold (e.g., |r|9 <λ). In some implementations, the unbiasing system 110 may determine that the first correlations between the first predictions and the biased protected dimensions are less than the threshold, which may indicate that the first model (M′) has been trained without considering the biased protected dimensions (P) and the secondary correlated protected dimensions.

FIG. 1G depicts an example of eliminating bias from the training data and may be referred to as protected blind learning with cross-augmented data. For example, the training data may be represented as a training data matrix U, the protected dimensions or categories may be represented as P, and the training data may include a number (n) of samples. The training data matrix (U) may include a set of samples containing the number (n) of u-dimensional vectors (e.g., represented as an n×u matrix). The protected dimensions (P) may include a set of p protected dimensions (e.g., represented as an n×p matrix), and the modified training data (B) may include a matrix created by removing columns represented by the protected dimensions P from the training data matrix U (e.g., B is an n×(u−p) matrix). The unbiasing system 110 may also remove dimensions or a set of dimensions (e.g., represented by an n×q dimensional matrix Q) that are highly positively or negatively correlated higher than another threshold (ρ) (e.g., ρ=0.9 and r<−p or r>ρ) associated with the protected dimensions (P) from the training data (e.g., resulting in a set B′, where B′ is an n×(u−p−q) matrix).

The unbiasing system 110 may reintroduce equivalent dimensions to replace the P and Q dimensions, and may include (e.g., in the equivalent dimensions) sampled values from the original dimensions (e.g., of P and Q), consistent with the original distribution. For example, if the original dimensions that were removed included a “gender” dimension, and the original distribution is a uniform distribution, the unbiasing system 110 may reintroduce a “gender-unbiased” dimension back with the values for gender, sampled from a uniform distribution. This may generate values in other non-P′ or non-Q′ dimensions without a high correlation with the values from the P′ or Q′ dimensions (e.g., to generate a new data set B″).

The unbiasing system 110 may train the first model (M″) with the modified training data (B′) and to generate the first trained model (M″). The unbiasing system 110 may train the second model (M) with the training data matrix (U) and to generate the second trained model (M). The unbiasing system 110 may process the test data (e.g., derived from the set B″ rather than B), with the first trained model (M″), to generate the first predictions, and may process the test data, with the second trained model (M), to generate the second predictions. The unbiasing system 110 may calculate first correlations (r) between the first predictions and the biased protected dimensions (P), and may calculate second correlations between the second predictions and the biased protected dimensions (P). The unbiasing system 110 may determine whether the first correlations (e.g., |r|) between the first predictions and the biased protected dimensions are less than the threshold (e.g., |r|9 <λ). In some implementations, the unbiasing system 110 may determine that the first correlations between the first predictions and the biased protected dimensions are less than the threshold, which may indicate that the first model (M″) has been trained without considering the biased protected dimensions (P) and the secondary correlated protected dimensions.

FIG. 1H depicts an example of eliminating bias from the training data and may be referred to as protected blind learning by separating and projecting recent trend components to data. For example, the training data may be represented as a training data matrix U, the protected dimensions or categories may be represented as P, and the training data may include a number (n) of samples. The training data matrix (U) may include a set of samples containing the number (n) of u-dimensional vectors (e.g., represented as an n×u matrix). The protected dimensions (P) may include a set of p protected dimensions (e.g., represented as an n×p matrix).

The unbiasing system 110 may separate, from the training data U, the protected dimensions P, the correlated dimensions Q (e.g., described above in connection with FIGS. 1F and 1G), predicted values Y, and timestamps of data V. The separated data may form a matrix (B) that is created by concatenating the matrices P, Q, Y and V. The unbiasing system 110 may reprocess the matrix (B), if required, to enable processing the matrix (B) as a time-series matrix (B′) (e.g., if a predicted value is categorical rather than numerical or logistical, one-hot encoding may be utilized to encode the category as a zero or a one, or if the samples have a timestamp, the timestamp may be utilized to order the data into time series samples). The unbiasing system 110 may perform a time series analysis on the time-series matrix (B′) using seasonality component(S) as a time dimension to create a time series decomposition (e.g., B′ (t)=T (t)+S (t)+R (t)) and may separate a trend component (T) from the seasonality component(S) and a residual component (R). The unbiasing system 110 may adjust the trend component (T) into a time-invariant function (e.g., T′ (t)) by using T′ (t)=C, where C is a constant derived from a weighted average of T (t) and where recent values of T (t+1) are weighted higher than earlier values of T (t). The unbiasing system 110 may reintroduce the trend function T′ (t) to the original set of decomposed functions and may create a new time series function B″ (t)=T′ (t)+S (t)+R (t). The unbiasing system 110 may add other dimensions from matrix (U) using a timestamp (F′) to create a training data matrix (B″).

The unbiasing system 110 may train the first model (M″) with the modified training data (B′″) and to generate the first trained model (M′). The unbiasing system 110 may train the second model (M) with the training data matrix (U) and to generate the second trained model (M). The unbiasing system 110 may process the test data (e.g., derived from the set B″ rather than B), with the first trained model (M″), to generate the first predictions, and may process the test data, with the second trained model (M), to generate the second predictions. The unbiasing system 110 may calculate first correlations (r) between the first predictions and the biased protected dimensions (P), and may calculate second correlations between the second predictions and the biased protected dimensions (P). The unbiasing system 110 may determine whether the first correlations (e.g., |r|) between the first predictions and the biased protected dimensions are less than the threshold (e.g., |r|9 <λ). In some implementations, the unbiasing system 110 may determine that the first correlations between the first predictions and the biased protected dimensions are less than the threshold, which may indicate that the first model (M′) has been trained without considering trend-based information related to the protected dimensions and secondary correlated dimensions to the protected dimensions.

In this way, the unbiasing system 110 reduces bias in the predictions generated using machine learning models. For example, by resampling or recreating training data by introducing a secondary trending function which is a flat horizontal line (T) with values derived from an end of a trend period rather than an original trend function (T), recreating the time-domain training data with this new trend function T, and reducing correlation of model predictions with protected dimensions, the unbiasing system 110 may enhance the integrity and reliability of machine learning models. This may facilitate deployment of machine learning models in sensitive applications, and may conserve resources by reducing the need for subsequent bias correction measures and model retraining. Thus, the unbiasing system 110 may conserve computing resources, networking resources, and/or other resources that would have otherwise been consumed by generating biased machine learning models, generating biased predictions with the biased machine learning models, retraining the biased machine learning models, identifying and correcting bias in training data utilized to train the machine learning models, and/or the like.

As indicated above, FIGS. 1A-1H are provided as an example. Other examples may differ from what is described with regard to FIGS. 1A-1H. The number and arrangement of devices shown in FIGS. 1A-1H are provided as an example. In practice, there may be additional devices, fewer devices, different devices, or differently arranged devices than those shown in FIGS. 1A-1H. Furthermore, two or more devices shown in FIGS. 1A-1H may be implemented within a single device, or a single device shown in FIGS. 1A-1H may be implemented as multiple, distributed devices. Additionally, or alternatively, a set of devices (e.g., one or more devices) shown in FIGS. 1A-1H may perform one or more functions described as being performed by another set of devices shown in FIGS. 1A-1H.

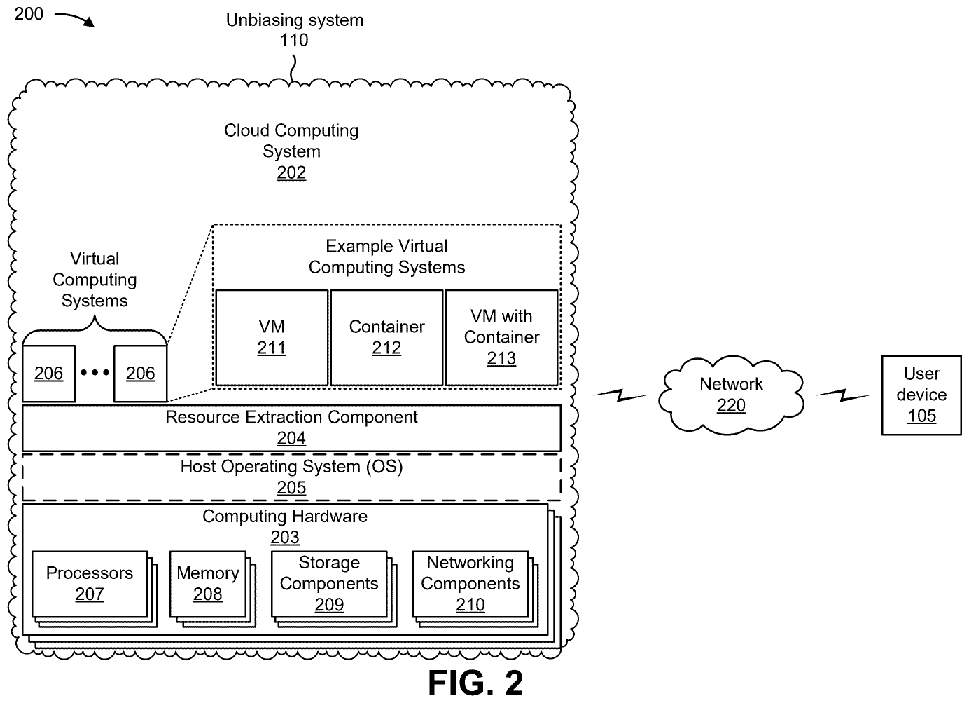

FIG. 2 is a diagram of an example environment 200 in which systems and/or methods described herein may be implemented. As shown in FIG. 2, the environment 200 may include the unbiasing system 110, which may include one or more elements of and/or may execute within a cloud computing system 202. The cloud computing system 202 may include one or more elements 203-213, as described in more detail below. As further shown in FIG. 2, the environment 200 may include the user device 105 and/or a network 220. Devices and/or elements of the environment 200 may interconnect via wired connections and/or wireless connections.

The user device 105 includes one or more devices capable of receiving, generating, storing, processing, and/or providing information, such as information described herein. For example, the user device 105 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a network device (e.g., customer premises equipment (CPE), a label switching router (LSR), a label edge router (LER), an ingress router, an egress router, a provider router, a virtual router, a gateway, a switch, a firewall, a hub, a bridge, a reverse proxy, a load balancer, and/or the like), or a similar type of device.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

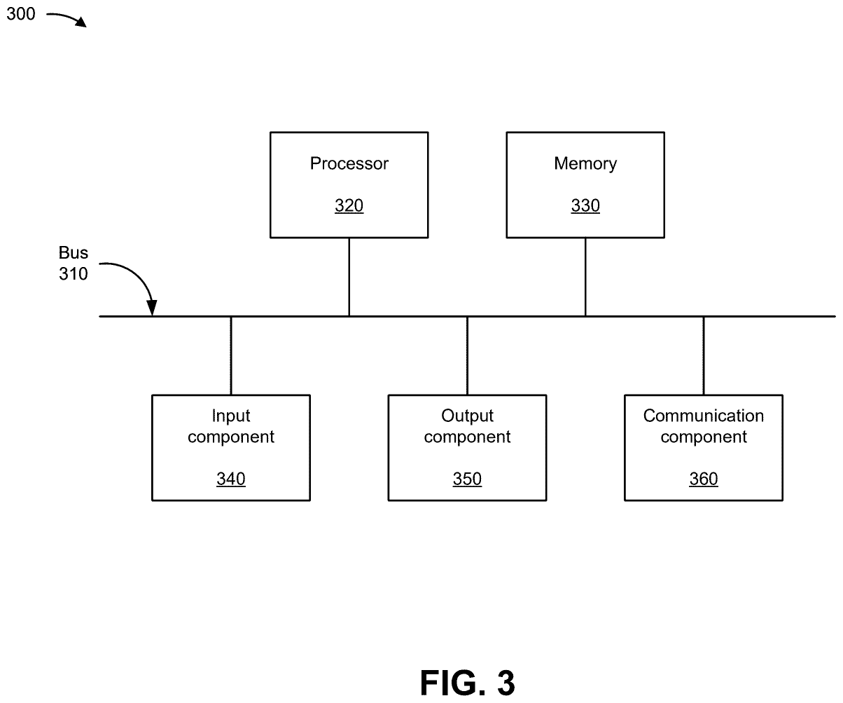

Although the unbiasing system 110 may include one or more elements 203-213 of the cloud computing system 202, may execute within the cloud computing system 202, and/or may be hosted within the cloud computing system 202, in some implementations, the unbiasing system 110 may not be cloud-based (e.g., may be implemented outside of a cloud computing system) or may be partially cloud-based. For example, the unbiasing system 110 may include one or more devices that are not part of the cloud computing system 202, such as the device 300 of FIG. 3, which may include a standalone server or another type of computing device. The unbiasing system 110 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the user device 105 and/or the unbiasing system 110. In some implementations, the user device 105 and/or the unbiasing system 110 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

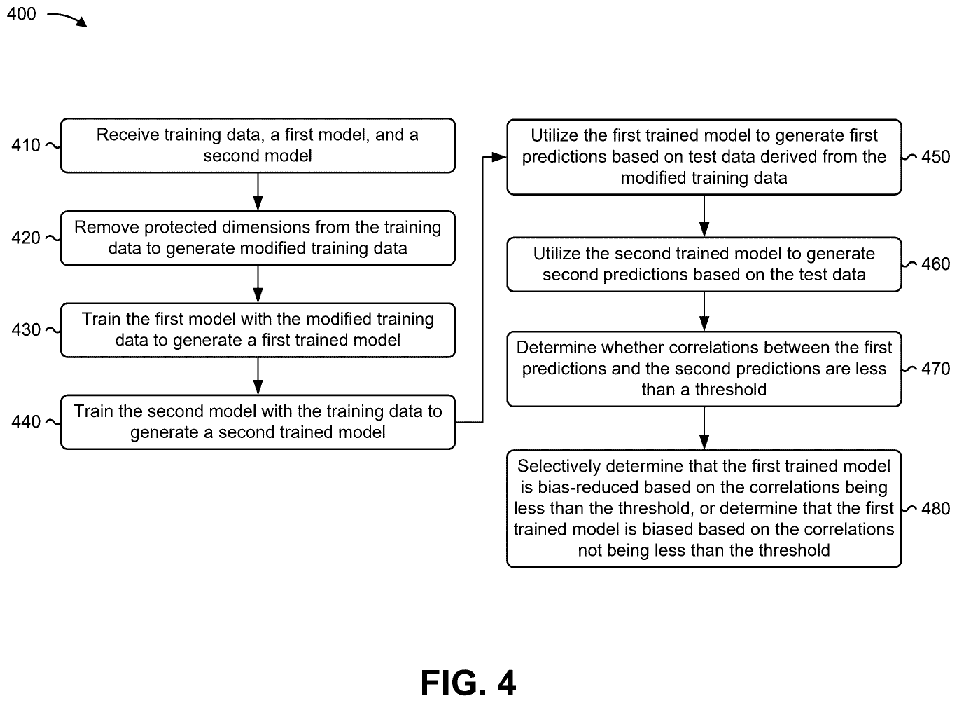

FIG. 4 is a flowchart of an example process 400 for reducing bias in machine learning models. In some implementations, one or more process blocks of FIG. 4 may be performed by a device (e.g., the unbiasing system 110). In some implementations, one or more process blocks of FIG. 4 may be performed by another device or a group of devices separate from or including the device, such as a user device (e.g., the user device 105). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving training data, a first model, and a second model (block 410). For example, the device may receive training data, a first model, and a second model, as described above. In some implementations, each of the first model and the second model is a machine learning model.

As further shown in FIG. 4, process 400 may include removing protected dimensions from the training data to generate modified training data (block 420). For example, the device may remove protected dimensions from the training data to generate modified training data, as described above. In some implementations, the training data includes a plurality of dimensions and the protected dimensions include one or more dimensions associated with historical bias.

As further shown in FIG. 4, process 400 may include training the first model with the modified training data to generate a first trained model (block 430). For example, the device may train the first model with the modified training data to generate a first trained model, as described above.

As further shown in FIG. 4, process 400 may include training the second model with the training data to generate a second trained model (block 440). For example, the device may train the second model with the training data to generate a second trained model, as described above.

As further shown in FIG. 4, process 400 may include utilizing the first trained model to generate first predictions based on test data derived from the modified training data (block 450). For example, the device may utilize the first trained model to generate first predictions based on test data derived from the modified training data, as described above. In some implementations, the test data is derived from the modified training data by excluding the protected dimensions from the modified training data.

As further shown in FIG. 4, process 400 may include utilizing the second trained model to generate second predictions based on the test data (block 460). For example, the device may utilize the second trained model to generate second predictions based on the test data, as described above.

As further shown in FIG. 4, process 400 may include determining whether correlations between the first predictions and the second predictions are less than a threshold (block 470). For example, the device may determine whether correlations between the first predictions and the second predictions are less than a threshold, as described above.

As further shown in FIG. 4, process 400 may include selectively determining that the first trained model is bias-reduced based on the correlations being less than the threshold, or determining that the first trained model is biased based on the correlations not being less than the threshold (block 480). For example, the device may selectively determine that the first trained model is bias-reduced based on the correlations being less than the threshold, or determine that the first trained model is biased based on the correlations not being less than the threshold, as described above.

In some implementations, process 400 includes implementing the first trained model based on determining that the first trained model is bias-reduced. In some implementations, process 400 includes retraining the first trained model based on determining that the first trained model is biased and to remove dimensions that are correlated with the protected dimensions. In some implementations, process 400 includes identifying one or more additional protected dimensions that cause the correlations to not be less than the threshold, and removing the one or more additional protected dimensions from the training data. In some implementations, process 400 includes removing secondary correlated protected dimensions from the modified training data prior to training the first model with the modified training data.

In some implementations, process 400 includes adding cross-augmented dimensions to the modified training data prior to training the first model with the modified training data. In some implementations, process 400 includes adding cross-augmented data to replace the protected dimensions prior to training the first model with the modified training data, wherein the cross-augmented data includes values consistent with an original distribution of the protected dimensions. In some implementations, process 400 includes removing trend-based information, related to the protected dimensions, from the modified training data prior to training the first model with the modified training data. In some implementations, process 400 includes adjusting the threshold prior to determining whether the correlations between the first predictions and the second predictions are less than the threshold. In some implementations, process 400 includes analyzing an impact of removing the protected dimensions on an accuracy of the first model.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, training data, a first model, and a second model;
removing, by the device, protected dimensions from the training data to generate modified training data;
training, by the device, the first model with the modified training data to generate a first trained model;
training, by the device, the second model with the training data to generate a second trained model;
utilizing, by the device, the first trained model to generate first predictions based on test data derived from the modified training data;
utilizing, by the device, the second trained model to generate second predictions based on the test data;
determining, by the device, whether correlations between the first predictions and the second predictions are less than a threshold; and
selectively:
determining, by the device, that the first trained model is bias-reduced based on the correlations being less than the threshold; or
determining, by the device, that the first trained model is biased based on the correlations not being less than the threshold.

2. The method of claim 1, further comprising:
implementing the first trained model based on determining that the first trained model is bias-reduced.

3. The method of claim 1, further comprising:
retraining the first trained model based on determining that the first trained model is generating biased predictions,
wherein the retraining includes removing dimensions that are correlated with the protected dimensions.

4. The method of claim 1, further comprising:
identifying one or more additional protected dimensions that cause the correlations to not be less than the threshold; and
removing the one or more additional protected dimensions from the training data.

5. The method of claim 1, wherein the training data includes a plurality of dimensions and the protected dimensions include one or more dimensions associated with historical bias.

6. The method of claim 1, wherein the test data is derived from the modified training data by excluding the protected dimensions from the modified training data.

7. The method of claim 1, further comprising:
removing secondary correlated protected dimensions from the modified training data prior to training the first model with the modified training data.

8. A device, comprising:
one or more processors configured to:
receive training data, a first model, and a second model;
remove protected dimensions from the training data to generate modified training data;
train the first model with the modified training data to generate a first trained model;
train the second model with the training data to generate a second trained model;
utilize the first trained model to generate first predictions based on test data derived from the modified training data;
utilize the second trained model to generate second predictions based on the test data;
determine whether correlations between the first predictions and the second predictions are less than a threshold;
determine that the first trained model is bias-reduced based on the correlations being less than the threshold; and
implement the first trained model based on determining that the first trained model is bias-reduced.

9. The device of claim 8, wherein the one or more processors are further configured to:
add cross-augmented dimensions to the modified training data prior to training the first model with the modified training data.

10. The device of claim 8, wherein the one or more processors are further configured to:
add cross-augmented data to replace the protected dimensions prior to training the first model with the modified training data,
wherein the cross-augmented data includes values consistent with an original distribution of the protected dimensions.

11. The device of claim 8, wherein the one or more processors are further configured to:
remove trend-based information, related to the protected dimensions, from the modified training data prior to training the first model with the modified training data.

12. The device of claim 8, wherein the one or more processors are further configured to:
adjust the threshold prior to determining whether the correlations between the first predictions and the second predictions are less than the threshold.

13. The device of claim 8, wherein the one or more processors are further configured to:
analyze an impact of removing the protected dimensions on an accuracy of the first model.

14. The device of claim 8, wherein the test data is derived from the modified training data by excluding the protected dimensions from the modified training data.

15. A non-transitory computer-readable medium storing a set of instructions, the set of instructions comprising:
one or more instructions that, when executed by one or more processors of a device, cause the device to:
receive training data, a first model, and a second model;
remove protected dimensions from the training data to generate modified training data;
train the first model with the modified training data to generate a first trained model;
train the second model with the training data to generate a second trained model;
utilize the first trained model to generate first predictions based on test data derived from the modified training data,
wherein the test data is derived from the modified training data by excluding the protected dimensions from the modified training data;
utilize the second trained model to generate second predictions based on the test data;
determine whether correlations between the first predictions and the second predictions are less than a threshold; and
selectively:
determine that the first trained model is bias-reduced based on the correlations being less than the threshold; or
determine that the first trained model is biased based on the correlations not being less than the threshold.

16. The non-transitory computer-readable medium of claim 15, wherein the one or more instructions further cause the device to:
implement the first trained model based on determining that the first trained model is bias-reduced.

17. The non-transitory computer-readable medium of claim 15, wherein the one or more instructions further cause the device to:
retrain the first trained model based on determining that the first trained model is biased.

18. The non-transitory computer-readable medium of claim 15, wherein the one or more instructions further cause the device to:
identify one or more additional protected dimensions that cause the correlations to not be less than the threshold; and
remove the one or more additional protected dimensions from the training data.

19. The non-transitory computer-readable medium of claim 15, wherein the one or more instructions further cause the device to:
remove secondary correlated protected dimensions from the modified training data prior to training the first model with the modified training data.

20. The non-transitory computer-readable medium of claim 15, wherein the one or more instructions further cause the device to:
add cross-augmented dimensions to the modified training data prior to training the first model with the modified training data.
